(19) United States
(12) Patent Application Publication
(10) Pub. No.: US 2014/0006835 A1
(43) Pub. Date: Jan. 2, 2014

(54) PROCESSING DEVICE AND CONTROL METHOD FOR SAME

(71) Applicant: Tomohiro Ono, Tokyo (JP)

(72) Inventor: Tomohiro Ono, Tokyo (JP)

(73) Assignee: NEC CORPORATION, Tokyo (JP)

(21) Appl. No.: 14/005,170

(22) PCT Filed: Jan. 20, 2012
(86) PCT No.: PCT/JP2012/051734

§ 371 Date: Sep. 13, 2013

(30) Foreign Application Priority Data
Mar. 16, 2011 (JP) 2011-057427

(51) Int. Cl. G06F 1/26

(52) U.S. Cl. CPC G06F 1/26
USPC 713/340

(57) ABSTRACT

A control method for a processing device including a plurality of functional blocks and a plurality of electric power reception units includes: periodically detecting or estimating a total amount of received electric power supplied to the plurality of electric power reception units to acquire total received electric power information indicative of the total amount of received electric power; and selectively controlling, based on the total received electric power information, supply of the total received electric power supplied to the plurality of electric power reception units to the plurality of functional blocks.

### TECHNICAL FIELD

This invention relates to a processing device, and more particularly, to a processing device including a plurality of functional blocks such as a wireless device and an information processing device, and a control method for the processing device.

### BACKGROUND ART

As widely known in the art, generally, a processing device comprises a plurality of functional blocks. The plurality of functional blocks may serve as different functions, or may serve as the same function. The processing device may be, for example, a wireless device or an information processing device.

The wireless device includes, as the plurality of functional blocks, for example, a plurality of communication functional blocks and other common portions. Each of the plurality of communication functional blocks comprises, for example, a modulation/demodulation circuit, a transmission/reception frequency conversion circuit, and an amplifier. Note that, depending on an environment of outside air, the wireless device may include any one of or both of a heater and a cooler.

In a conventional wireless device, nothing is taken into consideration for a case where an electric power supply is limited and a case where a supplied electric power decreases.

As prior art documents relating to this invention, the following documents are known.

For example, Patent Literature 1 discloses an “electric power reception device” for, when the electric power reception device detects abnormality, outputting an overcurrent to an electric power supply device to stop a supply of electric power from the electric power supply device.

Moreover, Patent Literature 2 discloses an “electric power supply device” for supplying a plurality of electric power reception devices with an electric power at different times.

Patent Literature 3 discloses a “wireless LAN device” which can sufficiently extend a drive time when the device is driven by a battery. In Patent Literature 3, a wireless LAN base unit is configured so as to be driven by a battery or an AC adaptor (external power supply). Then, in the battery-driven state, electric power supply to an electric power amplifier and a low-noise amplifier is stopped to greatly reduce the electric power consumption.

Patent Literature 4 discloses a “portable device” for efficiently using an electric power supplied via a connection interface which can supply an electric power. The portable device disclosed Patent Literature 4 is a portable device comprising a plurality of functional blocks serving as functions different from each other, and includes electric energy check means for checking an electric energy which can be supplied from an information processing device via a connection cable by means of communication with the information processing device, and electric power supply control means for controlling, based on the check result by the electric energy check means, supply of an electric power supplied from the information processing device via the connection cable to the plurality of functional blocks. The electric power supply control means includes storage means for storing electric power consumptions of the respective functional blocks and discrimination means for comparing the electric power consumptions stored in the storage means and an electric energy which can be supplied from the connection cable with each other to discriminate functional blocks which can be driven, and the electric power supply control means controls, based on a discrimination result by the discrimination means, the supply of the electric power supplied from the information processing device via the connection cable to the plurality of functional blocks.

According to Patent Literature 4, as the portable device, a digital camera is assumed, and, as the connection cable, a USB cable is assumed. Then, according to Patent Literature 4, when a personal computer (information processing device) is connected via the USB cable to the digital camera, a control unit checks, by means of communication with the personal computer, the electric energy which can be supplied from the personal computer, and controls, based on a result of the check, a power supply control circuit to supply predetermined functional blocks with the electric power from the personal computer. Note that, according to Patent Literature 4, the electric energy which can be supplied is checked only once when the connection is made via the USB cable to turn on the electric power.

If there is a limit on the electric power supply, or when a supplied electric power decreases, the conventional wireless devices have the following problems.

A first problem is that a received electric power cannot be detected, and thus the minimum operation depending on an environment cannot be carried out.

A second problem is that a received electric power cannot be estimated, and thus an optimum service depending on a demand cannot be carried out.

Patent Literature 1 only discloses the electric power reception device for, upon detection of abnormality, outputting an overcurrent to the electric power supply device to stop the supply of the electric power from the electric power supply device.

Patent Literature 2 only discloses the electric power supply device for supplying the plurality of electric power reception devices with the electric power at different times.

On the other hand, Patent Literatures 3 and 4 have problems described below.

Patent Literature 3 only considers the case where one AC adapter or one battery is used as the electric power supply means. Moreover, Patent Literature 3 only realizes the low electric power consumption by simply changing signal paths to reduce the amplification factors of the amplifiers during the battery drive.

According to Patent Literature 4, the electric energy which can be supplied is checked only once when the connection to the personal computer is made via the USB cable to turn on the electric power. As a result, finely-tuned control cannot be provided. Moreover, according to Patent Literature 4, a digital camera is assumed as the portable device, and thus a cooperation with an external device (such as monitoring/control terminal) is not taken into consideration.

### CITATION LIST

### Patent Literature

Patent Document 1: Japanese Unexamined Patent Application Publication (JP-A) No. 2008-294951
Patent Document 2: Japanese Unexamined Patent Application Publication (JP-A) No. 2008-154069
Patent Document 3: Japanese Unexamined Patent Application Publication (JP-A) No. 2010-273290
Patent Document 4: Japanese Unexamined Patent Application Publication (JP-A) No. 2001-100868

### SUMMARY OF INVENTION

It is an object of this invention to provide a processing device and a control method therefor to realize an optimal service or the minimum control operation.

A control method for a processing device according to this invention is a control method for a processing device including a plurality of functional blocks and a plurality of electric power reception units, wherein the method includes the steps of periodically detecting or estimating a total amount of received electric power supplied to the plurality of electric power reception units to acquire total received electric power information indicative of the total amount of received electric power; and of selectively controlling, based on the total received electric power information, supply of the total received electric power supplied to the plurality of electric power reception units to the plurality of functional blocks.

A processing device according to this invention is a processing device including a plurality of functional blocks and a plurality of electric power reception units, wherein the processing device comprises total received electric power acquisition means for periodically detecting or estimating a total amount of received electric power supplied to the plurality of electric power reception units to acquire total received electric power information indicative of the total amount of received electric power; and electric power supply control means for selectively controlling, based on the total received electric power information, supply of the total received electric power supplied to the plurality of electric power reception units to the plurality of functional blocks.

The processing device according to this invention can provide an optimal service or the minimum control operation by detecting or estimating the total received electric power.

### BRIEF DESCRIPTION OF THE DRAWINGS

FIG. 1 is a block diagram illustrating a configuration of a wireless device according to an embodiment of this invention;

FIG. 2 is a flowchart illustrating a detailed operation of an electric power consumption estimation by a plurality of electric power reception units and a plurality of current detection circuits of the wireless device illustrated in FIG. 1;

FIG. 3 is a sequence diagram illustrating a notification of a state where a minimum wireless service cannot be provided, which is issued from a calculation processing unit to a monitoring/control terminal;

FIG. 4 is a sequence diagram illustrating a notification of a state where all set services can be provided, which is issued from the calculation processing unit to the monitoring/control terminal;

FIG. 5 is a sequence diagram illustrating a notification of a state where none of the set services can be provided, which is issued from the calculation processing unit to the monitoring/control terminal;

FIG. 6 is a diagram illustrating an example of environment setting set from the external monitoring/control terminal to the calculation processing unit in the wireless device illustrated in FIG. 1; and

FIG. 7 is a diagram illustrating an example of wireless function setting (demand setting) set from the external monitoring/control terminal to the calculation processing unit in the wireless device illustrated in FIG. 1.

### MODE FOR EMBODYING THE INVENTION

A detailed description is now given of an exemplary embodiment of this invention.

A description is given of features of the exemplary embodiment of this invention.

The feature of the exemplary embodiment of this invention resides in that, in a wireless device comprising a plurality of modulation/demodulation circuits, a plurality of transmission/reception frequency conversion circuits, a plurality of amplifiers, a heater, and a cooler, functions are controlled depending on a purpose and an application within a limited electric power consumption or within the lowest electric power consumption.

A calculation processing unit of the wireless device supplies a possible and necessary number of systems including the plurality of modulation/demodulation circuits, the plurality of transmission/reception frequency conversion circuits, and the plurality of amplifiers with electric powers. Moreover, the calculation processing unit supplies the heater and the cooler with electric powers in priority over the plurality of modulation/demodulation circuits, the plurality of transmission/reception frequency conversion circuits, and the plurality of amplifiers depending on necessity.

In this way, according to the exemplary embodiment of this invention, a wireless service can be provided depending on a supplied electric power for consumption, a demand, and an environment.

### FIRST EMBODIMENT

A description is now given of a first embodiment of this invention as an example where a processing device is applied to a wireless device 10.

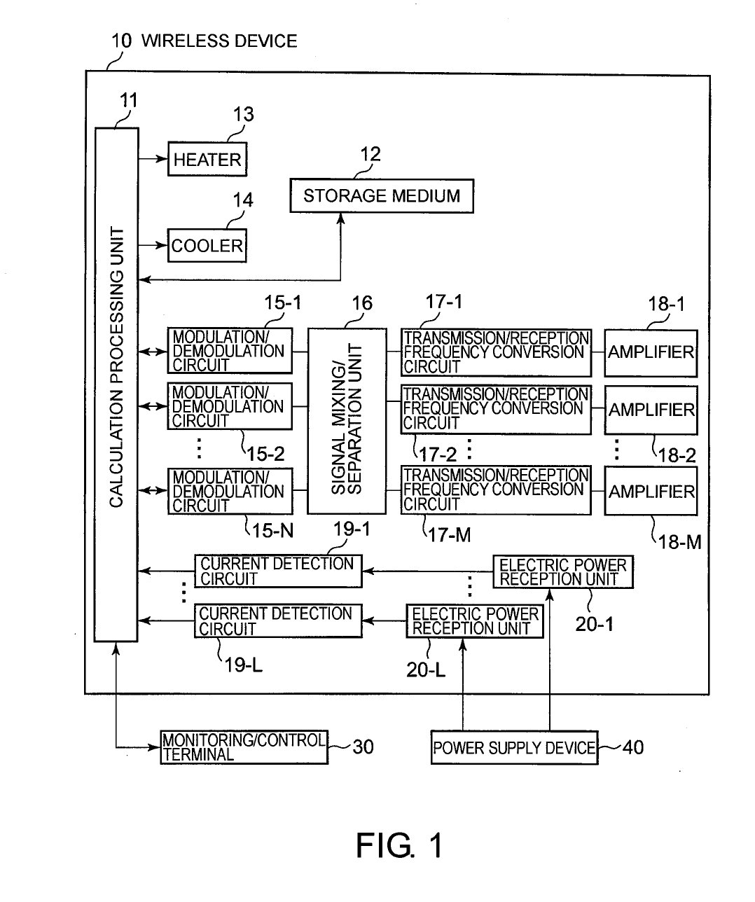

Referring to FIG. 1, as the embodiment of this invention, the wireless device 10 is illustrated. The wireless device 10 is connected to a monitoring/control terminal 30 and a power supply device 40.

The illustrated wireless device 10 includes a calculation processing unit 11, a storage medium 12, a heater 13, a cooler 14, first to N-th (N is an integer equal to or more than 2) modulation/demodulation circuits 15-1, 15-2, . . . , 15-N, a signal mixing/separation unit 16, first to M-th (M is an integer equal to or more than 2) transmission/reception frequency conversion circuits 17-1, 17-2, . . . , 17-M, first to M-th amplifiers 18-1, 18-2, . . . , 18-M, first to L-th (L is an integer equal to or more than 2) the current detection circuits 19-1, . . . , 19-L, and first to L-th electric power reception units 20-1, . . . , 20-L.

The calculation processing unit 11 is connected to the storage medium 12, the heater 13, the cooler 14, the first to the N-th modulation/demodulation circuits 15-1 to 15-N, the first to the L-th current detection circuits 19-1 to 19-L, and the monitoring/control terminal 30. The first to the N-th modulation/demodulation circuits 15-1 to 15-N are connected to the signal mixing/separation unit 16. The signal mixing/separation unit 16 is connected to the first to the M-th transmission/reception frequency conversion circuits 17-1 to 17-M. The first to the M-th transmission/reception frequency conversion circuits 17-1 to 17-M are connected to the first to the M-th amplifiers 18-1 to 18-M, respectively. The first to the L-th current detection circuits 19-1 to 19-L are connected to the first to the L-th electric power reception units 20-1 to 20-L, respectively. The first to the L-th electric power reception units 20-1 to 20-L are connected to the power supply device 40.

In FIG. 1, the calculation processing unit 11 sums electric powers available for consumption by using the first to the L-th electric power reception units 20-1 to 20-L and the first to the L-th current detection circuits 19-1 to 19-L, and enables/disables functions of the first to the N-th modulation/demodulation circuits 15-1 to 15-N, the first to the M-th transmission/reception frequency conversion circuits 17-1 to 17-M, the first to the M-th amplifiers 18-1 to 18-M, the one heater 13, and the one cooler 14 depending on a demand and an environment in the manner which will described later.

In the wireless device 10, each of the first to the N-th modulation/demodulation circuits 15-1 to 15-N is a circuit for modulating data into a baseband signal during transmission, and for demodulating the baseband signal into the data during reception.

Each of the first to the M-th transmission/reception frequency conversion circuits 17-1 to 17-M is a circuit for converting the baseband signal into an analog signal and converting the frequency of the analog signal during the transmission, and for converting the analog signal into the baseband signal during the reception.

Each of the first to the M-th amplifiers 18-1 to 18-M functions to increase gains of a transmission signal and a reception signal. The heater 13 functions to heat the wireless device 10 in a case where the temperature is low, or the like. The cooler 14 functions to cool the wireless device 10 in a case where the temperature is high, or the like.

Thus, the illustrated wireless device 10 includes, as a plurality of functional blocks, a plurality of communication functional blocks (described later), the one heater 13, and the one cooler 14. Basically, each of the communication functional blocks comprises a combination of one modulation/demodulation circuit 15-n (1≦n≦N), one transmission/reception frequency conversion circuit 17-m (1≦m≦M), and one amplifier 18-m. Note that, each of the communication functional blocks may comprise a combination of one modulation/demodulation circuit, two transmission/reception frequency conversion circuits, and two amplifiers. Alternatively, each of the communication functional blocks may comprise a combination of two modulation/demodulation circuits, one transmission/reception frequency conversion circuit, and one amplifier.

Note that, although both the number of transmission/reception frequency conversion circuits and the number of amplifies are equal to M in the illustrated example, the numbers may be different from each other. Moreover, although both the number of the current detection circuits and the number of the electric power reception units are equal to L, the numbers may be different from each other.

The calculation processing unit 11 in the wireless device 10 carries out negotiation by means of detection of a current by the first to the L-th electric power reception units 20-1 to 20-L and the first to the L-th current detection circuits 19-1 to 19-L, or of a protocol (such as IEEE802.3at and IEEE802.3af) used for the electric power reception.

The illustrated wireless device 10 includes the plurality of electric power reception units 20-1 to 20-L and the plurality of current detection circuits 19-1 to 19-L, and the calculation processing unit 11 thus sums current values detected by the plurality of current detection circuits 19-1 to 19-L to accumulate the current values as the total received electric power. In any case, the calculation processing unit 11 serves as, in cooperation with the first to the L-th current detection circuits 19-1 to 19-L, total received electric power acquisition means for periodically detecting the total amount of the received electric powers supplied to the first to the L-th electric power reception units 20-1 to 20-L to acquire total received electric power information indicative of the total amount of the received electric powers.

Alternatively, the calculation processing unit 11 serves as total received electric power acquisition means for periodically estimating the total amount of the received electric powers supplied to the first to the L-th electric power reception units 20-1 to 20-L to acquire total received electric power information indicative of the total amount of the received electric powers.

In the manner which will described later, the calculation processing unit 11 serves as electric power supply control means for selectively controlling, based on the total received electric power information, supply of the total received electric power supplied to the plurality of electric power reception units 20-1 to 20-L to the plurality of functional blocks.

The storage medium 12 preliminarily stores (saves), in the wireless device 10, electric power consumption information which indicates an electric power consumption of the common portion (not shown), an electric power consumption per circuit of the first to the N-th modulation/demodulation circuits 15-1 to 15-N, the first to the M-th transmission/reception frequency conversion circuits 17-1 to 17-M, and the first to the M-th amplifiers 18-1 to 18-M, and electric power consumptions of the heater 13 and the cooler 14 as known information. In any case, the storage medium 12 serves as storage means (storage device) for preliminarily storing the electric power consumption information indicative of the electric power consumption of each of the plurality of functional blocks.

The calculation processing unit 11 serves as the electric power supply control means for referring to the electric power consumption information stored in the storage medium 12, and for selectively controlling, based on the total received electric power information, the supply of the total received electric power supplied to the plurality of electric power reception units 20-1 to 20-L to the plurality of functional blocks.

In the manner which will be described later, if the calculation processing unit 11 determines that the total received electric power supplied to the plurality electric power reception units 20-1 to 20-L is insufficient for supply to any one of the plurality of functional blocks, the calculation processing unit 11 notifies the external monitoring/control terminal 30 of the insufficiency.

The monitoring/control terminal 30 serves, in the manner which will be described later, as environment setting means for enabling/disabling functions of the heater 13 and the cooler 14 to set the environment of the wireless device 10. Moreover, the monitoring/control terminal 30 serves, in the manner which will be described later, as demand setting means for setting priorities of functions of the plurality of components (namely, the modulation/demodulation circuits, the transmission/reception frequency conversion circuits, and the amplifiers) constituting each of the plurality of communication functional blocks to set the demand of the wireless device 10.

The calculation processing unit 11 serves, in the manner which will be described later, as the electric power supply control means for selectively controlling, based on the set environment, the set demand, and the total received electric power information, the supply of the total received electric power supplied to the plurality of electric power reception units 20-1 to 20-L to the plurality of functional blocks.

Thus, the wireless device 10 distributes, in the manner which will be described later, depending on the demand and the environment on a case-by-case basis, the summed total received electric power to the plurality of processing blocks to provide an optimal wireless service.

Note that, although the wireless device 10 according to this embodiment includes the environment setting means and the demand setting means, the wireless device 10 may include any one of them or none of them.

In the illustrated embodiment, the electric power is supplied from the power supply device 40 to the first to the L-th electric power reception units 20-1 to 20-L. On this occasion, in the illustrated embodiment, the first to the L-th electric power reception units 20-1 to 20-L receive the electric powers from a plurality of AC adaptors, a plurality of Ethernet (trademark) cables compliant to the Power over Ethernet (POE) (trademark)), or both the AC adaptors and the Ethernet (trademark) cables. Therefore, in this embodiment, the wireless device 10 includes the plurality of the electric power reception units 20-1 to 20-L and the plurality of the current detection circuits 19-1 to 19-L for the current detection therein.

In this way, such a configuration that the wireless device 10 includes a plurality of electric power reception units 20-1 to 20-L is one feature of this embodiment, and, therefore, such a sequence that the possible maximum electric power consumption is estimated is considered. A reason therefor is that one Ethernet cable or one AC adaptor (an Ethernet cable or an AC adaptor which is small in supplied electric power is used as a substitute) cannot sufficiently satisfy a temperature environment or a required performance.

Moreover, according to this embodiment, depending on an available electric power consumption and a required function, not only amplification factors of the plurality of amplifiers 18-1 to 18-M are decreased but also the plurality of modulation/demodulation circuits 15-1 to 15-N and the plurality of transmission/reception frequency conversion circuits 17-1 to 17-M are also controlled to be enabled/disabled. Moreover, according to this embodiment, depending on the temperature environment, the control of the heater 13 and the cooler 14 is considered.

This embodiment adapts to various situations such as a case where the power supply is turned on for the first time (a first AC adaptor or a first Ethernet cable is inserted), a case where the number of the AC adaptors or the Ethernet (trademark) cables increases subsequent to the first turning on of the power supply, and a case where the external monitoring/control terminal 30 makes a request. Therefore, the calculation processing unit (total received electric power acquisition means) 11 periodically detects or estimates the total amount of the received electric powers supplied to the plurality of the electric power reception units 20-1 to 20-L.

According to this embodiment, the priorities of the functions of the wireless device 10 are set from the external monitoring/control terminal 30. Moreover, if the wireless device 10 cannot be operated, the wireless device 10 notifies the external monitoring/control terminal 30 of the inoperable state.

Although the configuration of this embodiment is detailed above, the plurality of current detection circuits 19-1 to 19-L in FIG. 1 are well known to a person skilled in the art, and are not directly related to this embodiment, and a detailed configuration thereof is thus omitted.

Note that, in this embodiment, an estimation of the electric power available for consumption may be negotiated by means of the POE or POE+ compliant to the protocol of IEEE803.3 at or IEEE802.3af. In this case, the plurality of electric power reception units 20-1 to 20-L and the plurality of current detection circuits 19-1 to 19-L can be constituted by interfaces for the Ethernet and the RJ-45.

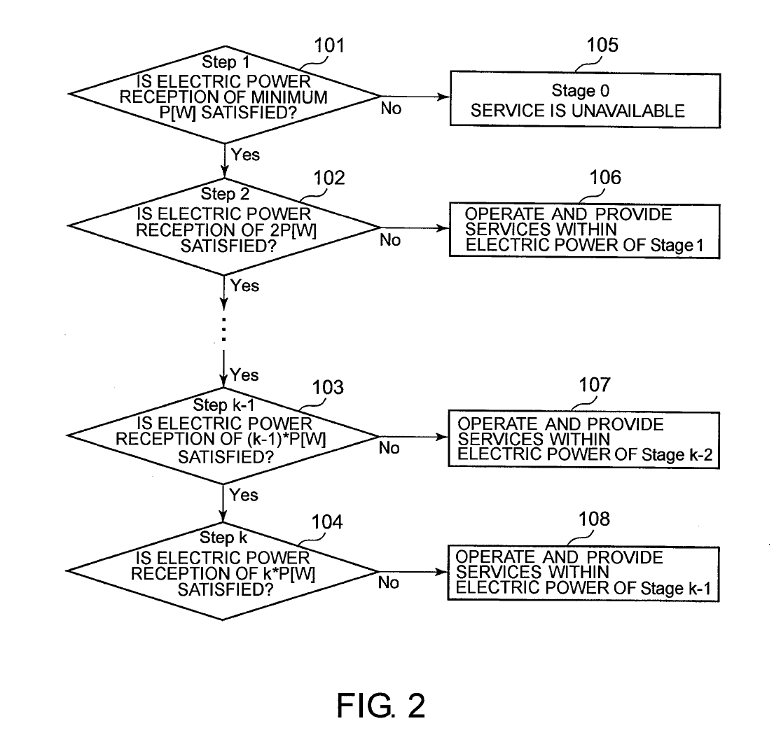

FIG. 2 is a detailed flowchart of the estimation of electric power consumed by the plurality of electric power reception units 20-1 to 20-L and the plurality of current detection circuits 19-1 to 19-L of the wireless device 10 in FIG. 1. In FIG. 2, the calculation processing unit 11 estimates the electric power available for consumption, and classifies the state into a plurality of Stages.

Now, referring to the flowchart in FIG. 2, a description is given of the operation of the function control of the wireless device 10 in FIG. 1.

In FIG. 2, the calculation processing unit 11 checks the electric power available for consumption in a step wise manner to determine to which Stage a state at this time corresponds (Steps 101 to 104).

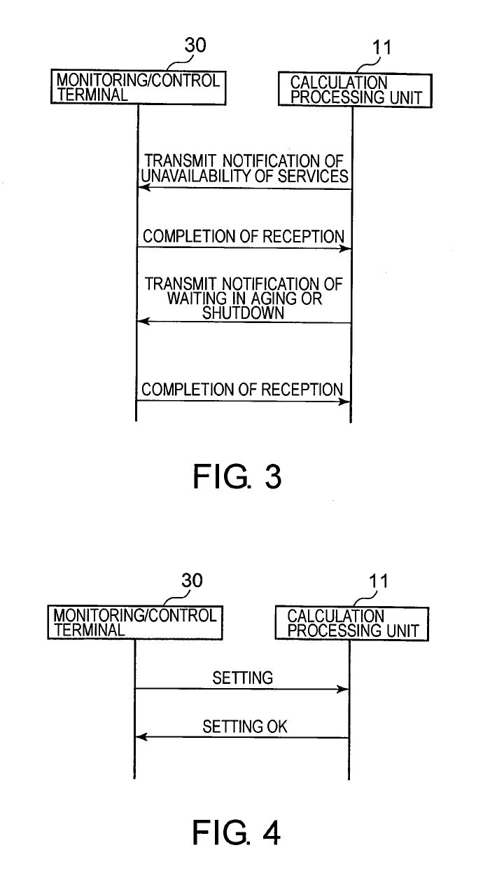

First, if the state is Stage 0, the state is a state where a minimum wireless service cannot be provided (Step 105), and the calculation processing unit 11 follows a sequence illustrated in FIG. 3 to notify the monitoring/control terminal 30 outside the wireless device 10 of the state. In this case, as illustrated in FIG. 3, the calculation processing unit 11 then notifies the monitoring/control terminal 30 of a state, “WAIT IN AGING” or “SHUTDOWN”.

If the external monitoring/control terminal 30 does not receive a notification, the monitoring/control terminal 30 determines that the calculation processing unit 11 has been “SHUT DOWN”. Regarding the determination of “WAIT IN AGING” or “SHUTDOWN”, the calculation processing unit 11 determines to carry out the shutdown when the state does not transition to Stage 1 even if a given period of time has elapsed since the calculation processing unit 11 waited in aging. The calculation processing unit 11 periodically checks whether the state has transitioned or not in the flowchart illustrated in FIG. 2 during the aging.

Then, Stage 1 represents a state where the minimum wireless service can be provided (Step 106), and Stage k-1 represents a state where the wireless service can be provided while all the functions are enabled (Step 108).

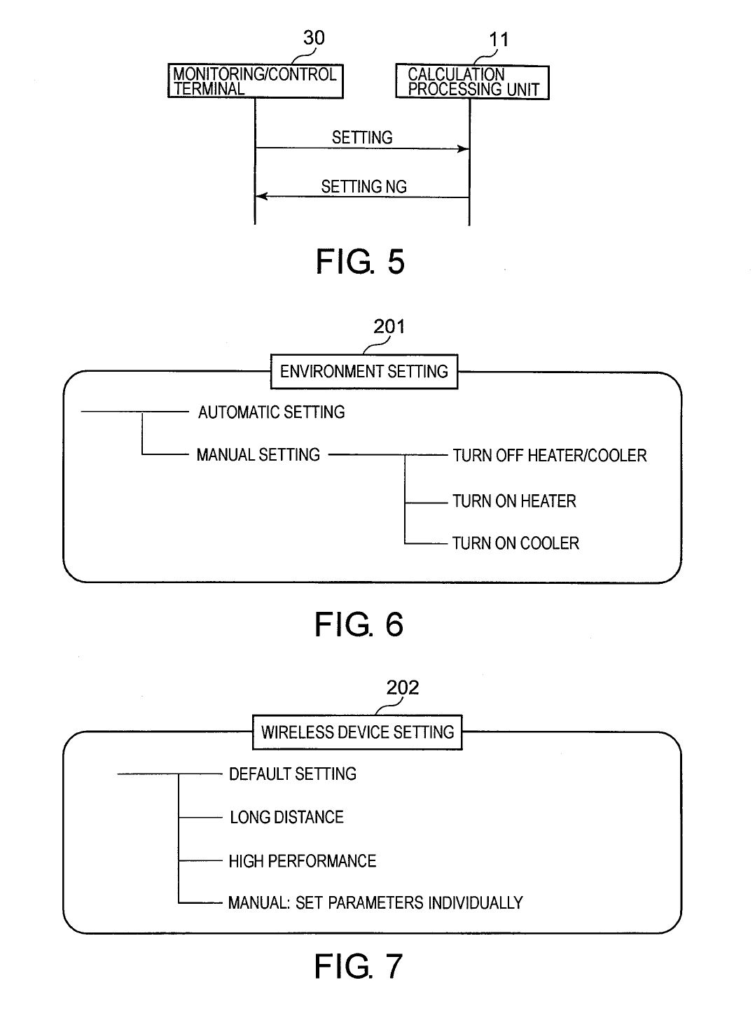

In this case, following a sequence illustrated in FIG. 4, from the external monitoring/control terminal 30, the functions (environment and demand) are set to the calculation processing unit 11 of the wireless device 10. If all the set services can be provided, the calculation processing unit 11 of the wireless device 10 follows the sequence illustrated in FIG. 4 to notify the monitoring/control terminal 30 of “SETTING OK”. If none of the set services can be provided, the calculation processing unit 11 notifies, as illustrated in a sequence of FIG. 5, the monitoring/control terminal 30 of a corresponding state, “SETTING NG”. In this case, again, the monitoring/control terminal 30 follows the sequence illustrated in FIG. 4 to carry out the setting.

As service contents of the wireless device 10, first, environment setting 201 illustrated in FIG. 6 is carried out, and, then, setting for wireless functions (demand) 202 illustrated in FIG. 7 is carried out.

In the environment setting 201 illustrated in FIG. 6, “AUTOMATIC SETTING” is a menu of automatically enabling/disabling the function of the heater 13 or the cooler 14. “MANUAL SETTING” is a menu of disabling both the functions of the heater 13 and the cooler 14, or individually enabling the function of the heater 13 and the function of the cooler 14.

Moreover, in the wireless function setting (demand setting) 202 illustrated in FIG. 7, “DEFAULT SETTING” is a menu of automatically enabling the functions of the plurality of modulation/demodulation circuits 15-1 to 15-N and the plurality of transmission/reception frequency conversion circuits 17-1 to 17-M, and setting the gains (amplification factors) of the plurality of amplifiers 18-1 to 18-M. “LONG DISTANCE” is a menu of setting, in priority, the gains (amplification factors) of the plurality of amplifiers 18-1 to 18-M. “HIGH PERFORMANCE” is a menu of enabling, in priority, the functions of plurality of the modulation/demodulation circuits 15-1 to 15-N and the plurality of transmission/reception conversion circuits 17-1 to 17-M. “MANUAL SETTING” is a menu of individually enabling the functions of the plurality of modulation/demodulation circuits 15-1 to 15-N and the plurality of transmission/reception frequency conversion circuits 17-1 to 17-M, and individually setting the gains (amplification factors) of the plurality of amplifiers 18-1 to 18-M.

In the storage medium 12 in the wireless device 10, the electric power consumption information indicative of the electric power consumption of the common portion (not shown), of the electric power consumption per circuit of the plurality of modulation/demodulation circuits 15-1 to 15-N, the plurality of transmission/reception frequency conversion circuits 17-1 to 17-M, and the plurality of amplifiers 18-1 to 18-M, and of the electric power consumptions of the heater 13 and the cooler 14 are stored in advance.

As a result, the calculation processing unit 11 selectively enables, within the electric power consumption of Stage determined based on the flowchart in FIG. 2, the functions of the plurality of functional blocks by following the settings in FIGS. 6 and 7.

As described above, in this embodiment, the following effects are provided.

A first effect is such a point that, when the received electric power is low, this state is discriminated, and hence the minimum wireless service can be provided depending on the demand and the environment.

A second effect is such a point that, when the received electric power increases, this state is periodically discriminated, and hence a wireless service on Stage higher by one level can be provided, depending on the demand and the environment.

A third effect is such a point that, when the received electric power is too low to provide the wireless service, the external monitoring/control terminal 30 can be notified of the state.

While the invention has been particularly shown and described with reference to the embodiments thereof, this invention is not limited to the these embodiments. It will be understood by those of ordinary skill in the art that various changes in form and details may be made therein without departing from the sprit and scope of the present invention as defined by the claims. For example, according to the embodiment, although the wireless device 10 comprises the one heater 13 and the one cooler 14, but depending on the environment of the outside air, both of them may be omitted, any one of them may be provided, or a plurality of them may be provided. Moreover, the number of the power supply devices 40 is not limited to one, and a plurality thereof may exist. This invention is not limited to the embodiment of the wireless device 10, and the same mechanism can be applied to an information processing device.

The whole or part of the exemplary embodiments disclosed above can be described as, but not limited to, the following supplementary notes.

(Supplementary note 1) A control method for a processing device comprising a plurality of functional blocks and a plurality of electric power reception units, the control method comprising the steps of:

periodically detecting or estimating a total amount of received electric power supplied to the plurality of electric power reception units to acquire total received electric power information indicative of the total amount of received electric power; and

selectively controlling, based on the total received electric power information, supply of the total received electric power supplied to the plurality of electric power reception units to the plurality of functional blocks.

(Supplementary note 2) A control method for a processing device according to Supplementary note 1, further comprising a step of preliminarily storing electric power consumption information indicative of an electric power consumption in each of the plurality of functional blocks in a storage device,

wherein the step of controlling refers to the electric power consumption information to distribute, based on the total received electric power information, the total received electric power supplied to the plurality of electric power reception units to the plurality of functional blocks.

(Supplementary note 3) A control method for a processing device according to Supplementary note 1 or 2, wherein the step of controlling notifies, when it is determined that the total received electric power supplied to the plurality of electric power reception units is insufficient for supply to any one of the plurality of functional blocks, an outside of the insufficiency.

(Supplementary note 4) A control method for a processing device according to any one of Supplementary notes 1 to 3,

wherein the processing device comprises a wireless device including, as the plurality of functional blocks, a plurality of communication functional blocks, a heater, and a cooler;

wherein the control method further includes a step of setting an environment of the wireless device by enabling/disabling functions of the heater and the cooler; and

wherein the step of controlling selectively controls, based on the set environment and the total received electric power information, the supply of the total received electric power supplied to the plurality of electric power reception units to the plurality of functional blocks.

(Supplementary note 5) A control method for a processing device according to any one of Supplementary notes 1 to 3,

wherein the processing device comprises a wireless device including a plurality of communication functional blocks as the plurality of functional blocks;

wherein the control method further comprises a step of setting a demand for the wireless device by setting priorities of functions of a plurality of components constituting each of the plurality of communication functional blocks; and

wherein the step of controlling selectively controls, based on the set demand and the total received electric power information, the supply of the total received electric power supplied to the plurality of electric power reception units to the plurality of functional blocks.

(Supplementary note 6) A control method for a processing device according to Supplementary note 5,

wherein the each of the plurality of communication functional blocks includes, as the plurality of components, at least one modulation/demodulation circuit, at least one transmission/reception frequency conversion circuit, and at least one amplifier; and

wherein the step of setting a demand for the wireless device sets, in priority, any one of functions of the at least one modulation/demodulation circuit and the at least one transmission/reception frequency conversion circuit and a gain of the at least one amplifier.

(Supplementary note 7) A control method for a processing device according to any one of Supplementary notes 1 to 3,

wherein the processing device comprises a wireless device including, as the plurality of functional blocks, a plurality of communication functional blocks, a heater, and a cooler;

wherein the control method further comprises the steps of:
setting an environment of the wireless device by enabling/disabling functions of the heater and the cooler; and
setting a demand for the wireless device by setting priorities of functions of a plurality of components constituting each of the plurality of communication functional blocks; and

wherein the step of controlling selectively controls, based on the set environment, the set demand, and the total received electric power information, the supply of the total received electric power supplied to the plurality of electric power reception units to the plurality of functional blocks.

(Supplementary note 8) A processing device comprising a plurality of functional blocks and a plurality of electric power reception units, wherein the processing device comprises:

total received electric power acquisition means for periodically detecting or estimating a total amount of received electric power supplied to the plurality of electric power reception units to acquire total received electric power information indicative of the total amount of received electric power; and

electric power supply control means for selectively controlling, based on the total received electric power information, supply of the total received electric power supplied to the plurality of electric power reception units to the plurality of functional blocks.

(Supplementary note 9) A processing device according to Supplementary note 8, further comprising storage means for preliminarily storing electric power consumption information indicative of an electric power consumption in each of the plurality of functional blocks,

wherein the electric power supply control means refers to the electric power consumption information to distribute, based on the total received electric power information, the total received electric power supplied to the plurality of electric power reception units to the plurality of functional blocks.

(Supplementary note 10) A processing device according to Supplementary note 8 or 9, wherein, when it is determined that the total received electric power supplied to the plurality of electric power reception units is insufficient for supply to any one of the plurality of functional blocks, the electric power supply control means notifies an outside of the insufficiency.

(Supplementary note 11) A processing device according to any one of Supplementary notes 8 to 10,

wherein the processing device comprises a wireless device including, as the plurality of functional blocks, a plurality of communication functional blocks, a heater, and a cooler;

wherein the processing device further comprises environment setting means for setting an environment of the wireless device by enabling/disabling functions of the heater and the cooler; and

wherein the electric power supply control means selectively controls, based on the set environment and the total received electric power information, the supply of the total received electric power supplied to the plurality of electric power reception units to the plurality of functional blocks.

(Supplementary note 12) A processing device according to any one of Supplementary notes 8 to 10,

wherein the processing device comprises a wireless device including a plurality of communication functional blocks as the plurality of functional blocks;

wherein the processing device further comprises demand setting means for setting a demand for the wireless device by setting priorities of functions of a plurality of components constituting each of the plurality of communication functional blocks; and

wherein the electric power supply control means selectively controls, based on the set demand and the total received electric power information, the supply of the total received electric power supplied to the plurality of electric power reception units to the plurality of functional blocks.

(Supplementary note 13) A processing device according to Supplementary note 12,

wherein the each of the plurality of communication functional blocks includes, as the plurality of components, at least one modulation/demodulation circuit, at least one transmission/reception frequency conversion circuit, and at least one amplifier; and

wherein the demand setting means sets, in priority, any one of functions of the at least one modulation/demodulation circuit and the at least one transmission/reception frequency conversion circuit and a gain of the at least one amplifier.

(Supplementary note 14) A processing device according to any one of Supplementary notes 8 to 10,

wherein the processing device comprises a wireless device including, as the plurality of functional blocks, a plurality of communication functional blocks, a heater, and a cooler;

wherein the processing device further comprises:
environment setting means for setting an environment of the wireless device by enabling/disabling functions of the heater and the cooler; and
demand setting means for setting a demand for the wireless device by setting priorities of functions of a plurality of components constituting each of the plurality of communication functional blocks; and

wherein the electric power supply control means selectively controls, based on the set environment, the set demand, and the total received electric power information, the supply of the total received electric power supplied to the plurality of electric power reception units to the plurality of functional blocks.

This application is based upon and claims the benefit of priority from Japanese patent application No. 2011-057427, filed on Mar. 16, 2011, the disclosure of which is incorporated herein in its entirety by reference.

1. A control method for a processing device comprising a plurality of functional blocks and a plurality of electric power reception units, the control method comprising:
periodically detecting or estimating a total amount of received electric power supplied to the plurality of electric power reception units to acquire total received electric power information indicative of the total amount of received electric power; and
selectively controlling, based on the total received electric power information, supply of the total received electric power supplied to the plurality of electric power reception units to the plurality of functional blocks.

2. A control method for a processing device according to claim 1, further comprising preliminarily storing electric power consumption information indicative of an electric power consumption in each of the plurality of functional blocks in a storage device,
wherein the controlling refers to the electric power consumption information to distribute, based on the total received electric power information, the total received electric power supplied to the plurality of electric power reception units to the plurality of functional blocks.

3. A control method for a processing device according to claim 1, wherein the controlling notifies, when it is determined that the total received electric power supplied to the plurality of electric power reception units is insufficient for supply to any one of the plurality of functional blocks, an outside of the insufficiency.

4. A control method for a processing device according to claim 1,
wherein the processing device comprises a wireless device including, as the plurality of functional blocks, a plurality of communication functional blocks, a heater, and a cooler;
wherein the control method further comprises setting an environment of the wireless device by enabling/disabling functions of the heater and the cooler; and
wherein the controlling selectively controls, based on the set environment and the total received electric power information, the supply of the total received electric power supplied to the plurality of electric power reception units to the plurality of functional blocks.

5. A control method for a processing device according to claim 1,
wherein the processing device comprises a wireless device including a plurality of communication functional blocks as the plurality of functional blocks;
wherein the control method further comprises setting a demand for the wireless device by setting priorities of functions of a plurality of components constituting each of the plurality of communication functional blocks; and
wherein the controlling selectively controls, based on the set demand and the total received electric power information, the supply of the total received electric power supplied to the plurality of electric power reception units to the plurality of functional blocks.

6. A control method for a processing device according to claim 5,
wherein the each of the plurality of communication functional blocks includes, as the plurality of components, at least one modulation/demodulation circuit, at least one transmission/reception frequency conversion circuit, and at least one amplifier; and
wherein the setting a demand for the wireless device sets, in priority, any one of functions of the at least one modulation/demodulation circuit and the at least one transmission/reception frequency conversion circuit, and a gain of the at least one amplifier.

7. A control method for a processing device according to claim 1,
wherein the processing device comprises a wireless device including, as the plurality of functional blocks, a plurality of communication functional blocks, a heater, and a cooler;
wherein the control method further comprises:
setting an environment of the wireless device by enabling/disabling functions of the heater and the cooler; and
setting a demand for the wireless device by setting priorities of functions of a plurality of components constituting each of the plurality of communication functional blocks; and
wherein the controlling selectively controls, based on the set environment, the set demand, and the total received electric power information, the supply of the total received electric power supplied to the plurality of electric power reception units to the plurality of functional blocks.

8. A processing device comprising a plurality of functional blocks and a plurality of electric power reception units, wherein the processing device comprises:
a total received electric power acquisition unit periodically detecting or estimating a total amount of received electric power supplied to the plurality of electric power reception units to acquire total received electric power information indicative of the total amount of received electric power; and
an electric power supply control unit selectively controlling, based on the total received electric power information, supply of the total received electric power supplied to the plurality of electric power reception units to the plurality of functional blocks.

9. A processing device according to claim 8, further comprising a storage unit preliminarily storing electric power consumption information indicative of an electric power consumption in each of the plurality of functional blocks,
wherein the electric power supply control unit refers to the electric power consumption information to distribute, based on the total received electric power information, the total received electric power supplied to the plurality of electric power reception units to the plurality of functional blocks.

10. A processing device according to claim 8, wherein, when it is determined that the total received electric power supplied to the plurality of electric power reception units is insufficient for supply to any one of the plurality of functional blocks, the electric power supply control unit notifies an outside of the insufficiency.

11. A processing device according to claim 8,
wherein the processing device comprises a wireless device including, as the plurality of functional blocks, a plurality of communication functional blocks, a heater, and a cooler;
wherein the processing device further comprises an environment setting unit setting an environment of the wireless device by enabling/disabling functions of the heater and the cooler; and
wherein the electric power supply control unit selectively controls, based on the set environment and the total received electric power information, the supply of the total received electric power supplied to the plurality of electric power reception units to the plurality of functional blocks.

12. A processing device according to claim 8,
wherein the processing device comprises a wireless device including a plurality of communication functional blocks as the plurality of functional blocks;
wherein the processing device further comprises a demand setting unit setting a demand for the wireless device by setting priorities of functions of a plurality of components constituting each of the plurality of communication functional blocks; and
wherein the electric power supply control unit selectively controls, based on the set demand and the total received electric power information, the supply of the total received electric power supplied to the plurality of electric power reception units to the plurality of functional blocks.

13. A processing device according to claim 12,
wherein the each of the plurality of communication functional blocks includes, as the plurality of components, at least one modulation/demodulation circuit, at least one transmission/reception frequency conversion circuit, and at least one amplifier; and
wherein the demand setting unit sets, in priority, any one of functions of the at least one modulation/demodulation circuit and the at least one transmission/reception frequency conversion circuit, and a gain of the at least one amplifier.

14. A processing device according to claim 8,
wherein the processing device comprises a wireless device including, as the plurality of functional blocks, a plurality of communication functional blocks, a heater, and a cooler;
wherein the processing device further comprises:
an environment setting unit setting an environment of the wireless device by enabling/disabling functions of the heater and the cooler; and
a demand setting unit setting a demand for the wireless device by setting priorities of functions of a plurality of components constituting each of the plurality of communication functional blocks; and
wherein the electric power supply control unit selectively controls, based on the set environment, the set demand, and the total received electric power information, the supply of the total received electric power supplied to the plurality of electric power reception units to the plurality of functional blocks.
